(19) United States
(12) Patent Application Publication
(10) Pub. No.: US 2018/0275751 A1
(43) Pub. Date: Sep. 27, 2018

(54) INDEX, SEARCH, AND RETRIEVAL OF USER-INTERFACE CONTENT

(71) Applicant: Microsoft Technology Licensing, LLC, Redmond, WA (US)

(72) Inventors: Andrew D. Wilson, Seattle, WA (US); Michael Mauderer, Redmond, WA (US)

(21) Appl. No.: 15/465,341

(22) Filed: Mar. 21, 2017

(51) Int. Cl. G06F 3/01; G06F 3/0484; G06F 17/30

(52) U.S. Cl. CPC G06F 3/013; G06F 3/04842; G06F 2203/04803; G06F 17/30256; G06F 17/3028

(57) ABSTRACT

Systems and methods are disclosed for the index, search, and retrieval of user interface content. In one implementation, an image of a user interface as presented to a user via a display device can be captured. The image can be processed to identify a content element depicted within the image. The content element can be associated with the image. The image as associated with the content element can be stored in relation to the user.

### TECHNICAL FIELD

Aspects and implementations of the present disclosure relate to data processing and, more specifically, but without limitation, to the index, search, and retrieval of user-interface content.

### BACKGROUND

Existing search technologies can generate a search index over a set of text-based documents stored at a particular location (e.g., on a device). The index can then be used to retrieve such documents in response to a search query.

### SUMMARY

The following presents a shortened summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a compact form as a prelude to the more detailed description that is presented later.

In one aspect of the present disclosure, an image of a user interface as presented to a user via a display device can be captured. The image can be processed to identify a content element depicted within the image. The content element can be associated with the image. The images as associated with the content element can be stored in relation to the user.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 is a block diagram of the device of FIG. 1, according to an example embodiment.

FIG. 3 illustrates one example scenario described herein, according to an example embodiment.

FIG. 4 is a flow chart illustrating a method, in accordance with an example embodiment, for the index, search, and retrieval of user-interface content.

FIG. 5 illustrates one example scenario described herein, according to an example embodiment.

FIG. 6 illustrates one example scenario described herein, according to an example embodiment.

FIG. 7 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to the index, search, and retrieval of user-interface content.

It can be appreciated that existing search and indexing technologies can enable users to identify and retrieve certain types of content. For example, text or text-based documents (e.g., files in .txt, .doc, .rtf, etc., formats) that are stored on a device can be indexed such that a user can utilize a single search interface to search (e.g., for a search term/query) across such documents.

However, while the referenced search/indexing is effective for such text-based documents (e.g., those stored/maintained on a device), in many scenarios a user can encounter content (e.g., text, media, etc.) that may not be stored (or may not be stored permanently) on the device. For example, a user can read content from a web page via a web browser, view media content (e.g., a streaming video) via, a media player application, etc. in such cases, the underlying content (e.g., the text/content from the web page, etc.) may not be stored (or may not be stored permanently) on the device through which it is viewed. Accordingly, in a scenario in which a user wishes to search for/retrieve content (e.g., on a particular topic, etc.), existing search/indexing technologies may only retrieve documents, etc., that are stored on a particular device or a particular format (e.g., text). However, such technologies are ineffective/unable to retrieve content that the user may have previously viewed (e.g., within a webpage, etc.) but is otherwise not presently stored on the device.

Accordingly, described herein in various implementations are technologies, including methods, machine readable mediums, and systems, that enable image(s) (e.g., still images and/or video) of the user interface of a device to be captured, e.g., on an ongoing basis. Such image(s) can reflect the content being depicted to the user (e.g., content being shown within a web browser, media player, etc.). Such captured image(s) can then be processed to identify various content elements (e.g., words, terms, etc.) present within the image(s). Such content items can be associated with the captured images and a search index can be generated based on the content elements. Subsequently, upon receiving a search query from the user, the referenced index can be used to identify previous instances in which corresponding content item(s) were presented to the user (e.g., within a webpage, media player, etc.). The captured image(s) associated with such instances can then be retrieved and presented to the user. In doing so, the user can retrieve and review content that he/she has viewed in the past, even in scenarios in which the applications that present the content (e.g., a web browser, media player, etc.) may not maintain copies of such content.

Additionally, in certain implementations various aspects of the described technologies can be further enhanced when employed in conjunction with various eye-tracking techniques. That is, it can be appreciated that a user may not necessarily view, read, etc. all of the content displayed/presented within a user interface (e.g., in a scenario in which a user has multiple applications open within a user interface, while only viewing/reading one of them). Accordingly, in certain implementations, in lieu of processing and/or indexing all content presented at a user interface (even such content that the user may not have actually viewed/read), various eye-tracking technologies can be utilized to identify those regions, portions, etc., of the user interface that the user is actually viewing. In doing so, such identified region(s) may be processed, indexed, etc., while other regions (which the user is not determined to be looking at) may not be. In doing so, the described technologies can enhance the efficiency and improve the resource utilization associated with the various operations. For example, the capture, processing, indexing, and/or storage operations can be limited to those region(s) at which the user is determined to be looking at, thereby improving the operation of the device(s) on which such operations(s) are executing. Additionally, the results generated/provided (e.g., in response to a search query) are likely to be more accurate/relevant in scenarios in which eye-tracking is employed.

It can therefore be appreciated that the described technologies are directed to and address specific technical challenges and longstanding deficiencies in multiple technical areas, including but not limited to image processing, content indexing, search and retrieval, and eye tracking. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

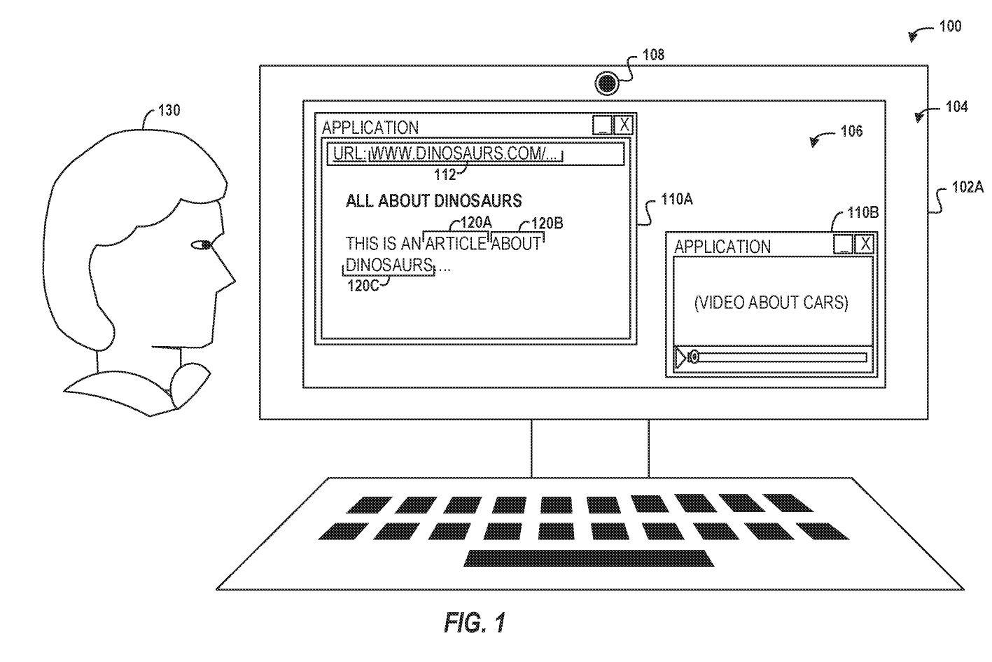

FIG. 1 illustrates an example system 100, in accordance with some implementations. As shown, the system 100 includes device 102A. Device 102A can be a laptop computer, a desktop computer, a terminal, a mobile phone, a tablet computer, a smart watch, a personal digital assistant (PDA), a wearable device, a digital music player, a server, and the like. User 130 can be a human user who may interact with device 102A, such as by providing various inputs (e.g., via an input device/interface such as a keyboard, mouse, touchscreen, etc.).

In certain implementations, device 102A can include or otherwise be connected to various components such as display device 104 and one or more tracking component(s) 108. Display device 104 can be, for example, a light emitting diode (LED) display, a liquid crystal display (LCD) display, a touchscreen display, and/or any other such device capable of displaying, depicting, or otherwise presenting user interface 106 (e.g., a graphical user interface (GUI)). Tracking component(s) 108 can be, for example, a sensor (e.g., an optical sensor), a camera (e.g., a two-dimensional or three-dimensional camera), and/or any other such device capable of tracking the eyes of user 130, as described herein. It should be understood that while FIG. 1 depicts display device 104 and tracking component(s) 108 as being integrated within a single device 102A (such as in the case of a laptop computer with an integrated webcam or a tablet/smartphone device with an integrated front-facing camera), in other implementations display device 104 and tracking component(s) 108 can be separate elements (e.g., when using a peripheral webcam device).

For example, as shown in FIG. 1, device 102A can present user interface 106 to user 130 via display device 104. User interface 106 can he a graphical depiction of various applications executing on device 102A (and/or any other such content displayed or depicted via display device 104), such as application 110A (which can be, for example, a web browser) and application 110B (which can be, for example, a media/video player). Such application(s) can also include or otherwise reflect various content elements (e.g., content elements 120A, 120B, and 120C as shown in FIG. 1). Such content elements can be, for example, alphanumeric characters or strings, words, text, images, media (e.g., video), and/or any other such electronic or digital content that can be displayed, depicted, or otherwise presented via device 102A. Various applications can also depict, reflect, or otherwise he associated with a content location 112. Content location 112 can include or otherwise reflect a local and/or network/remote location where various content elements can be stored or located (e.g., a Uniform Resource Locator (URL), local or remote/network file location/path, etc.).

It should be noted that while FIG. 1 (as well as various other examples and illustrations provided herein) depicts device 102A as being a laptop or desktop computing device, this is simply for the sake of clarity and brevity. Accordingly, in other implementations device 102A can he various other types of devices, including but not limited to various wearable devices.

For example, in certain implementations device 102A can be a virtual reality (VR) and/or augmented reality (AR) headset. Such a headset can be configured to be worn on or positioned near the head, face, or eyes of a user. Content such as immersive visual content (that spans most or all of the field of view of the user) can be presented to the user via the headset. Accordingly, such a VR/AR headset can include or incorporate components that correspond to those depicted in FIG. 1 and/or described herein.

By way of illustration, a VR headset can include a display device, e.g., one or more screens, displays, etc., included/incorporated within the headset. Such screens, displays, etc., can be configured to present/project a VR user interface to the user wearing the headset. Additionally, the displayed VR user interface can further include visual/graphical depictions of various applications (e.g., VR applications) executing on the headset (or on another computing device connected to or in communication with the headset).

Additionally, in certain implementations such a headset can include or incorporate tracking component(s) such as are described/referenced herein. For example, a VR headset can include sensor(s), camera(s), and/or any other such component(s) capable of detecting motion or otherwise tracking the eyes of user (e.g., while wearing or utilizing the headset). Accordingly, the various examples and illustrations provided herein (e.g., with respect to the device 102A) should be understood to be non-limiting as the described technologies can also be implemented in other settings, contexts, etc. (e.g., with respect to a VR/AR headset)

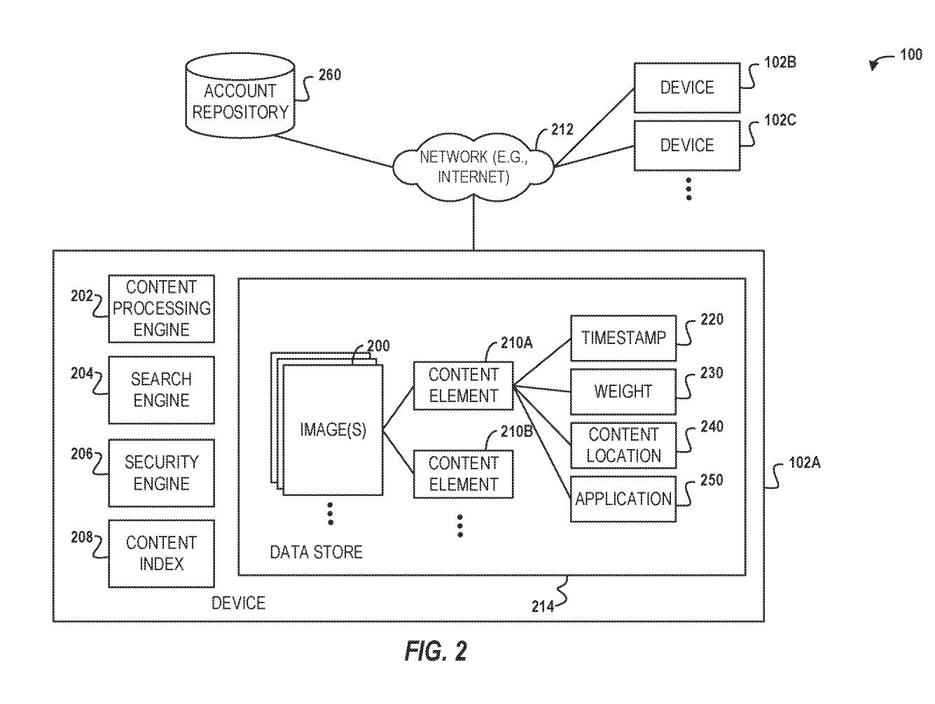

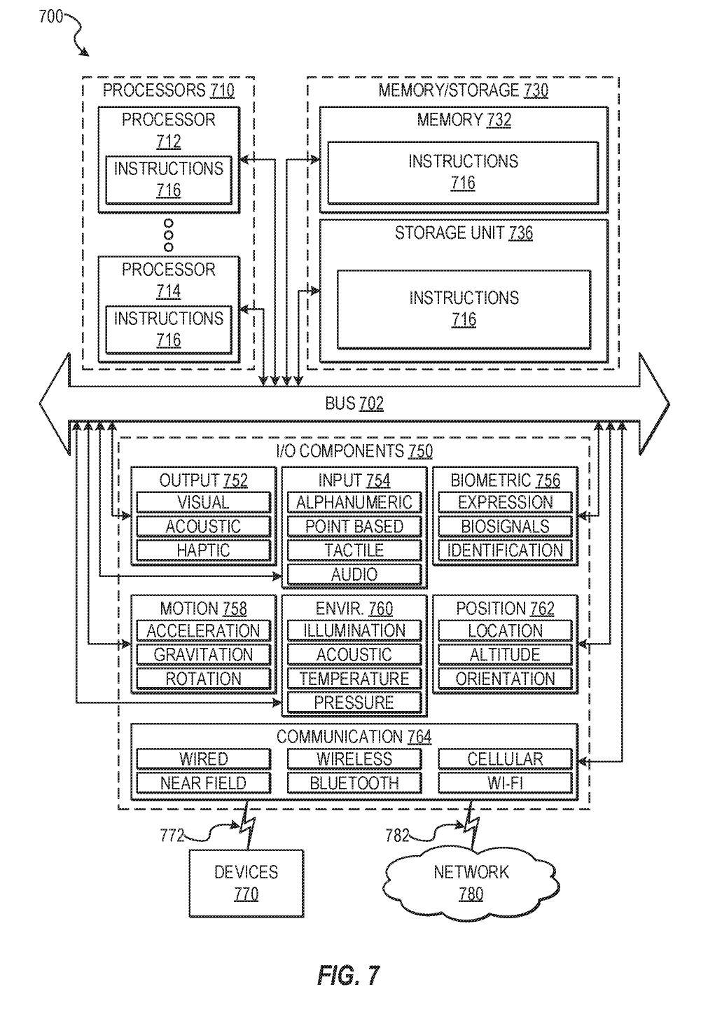

FIG. 2 depicts a block diagram showing further aspects of system 100, in accordance with an example embodiment. As shown in FIG. 2, device 102A can include content processing engine 202, search engine 204, and security engine 206. Each of processing engine 202, search engine 204, and security engine 206 can be, for example, an application or module stored on device 102A (e.g., in memory of device 102A, such as memory 730 as depicted in FIG. 7 and described in greater detail below). When executed (e.g., by one or more processors of device 102A such as processors 710 as depicted in FIG. 7 and described in greater detail below), such application, module, etc. configures or otherwise enables the device to perform various operations such as are described herein.

For example, content processing engine 202 can configure/enable device 102A to capture image(s) 200. Such image(s) 200 can be, images (e.g., still images, video, or any other such graphical format) of user interface 106 as depicted to user 130 via display device 104 of device 102A. As described in greater detail below, image(s) 200 can include the entire user interface 106 as shown on display device 104, and/or a portion thereof (e.g., a particular segment or region of the user interface or a particular application). In certain implementations, content processing engine 202 can further configure or enable device 102A to process the captured image(s). In doing so, various content elements (e.g., content element 210A and content element 210B) that are depicted or otherwise reflected within the image(s) 200 can be identified or otherwise extracted. For example, content processing engine 202 can utilize various optical character recognition (OCR) techniques to identify alphanumeric content (e.g., text) within the image(s) 200. By way of further example, content processing engine 202 can utilize various image analysis/object recognition techniques to identify graphical content (e.g., an image of a particular object) within the image(s) 200.

Content processing engine 202 can also configure or enable device 102A to identify additional information within and/or in relation to image(s) 200. For example, timestamp 220 can reflect chronological information (e.g., time(s), date(s), duration(s), etc.) during which particular content element(s) (e.g., content element 210A) were displayed to/viewable by user 130 via display device 104 of device 102A. Additionally, in certain implementations, content processing engine 202 can compute and/or assign a weight 230, e.g., to a particular content element. Such a weight 230 (which can be, for example, a numerical score computed based on timestamp 220) can reflect the relative significance or importance of the content element. The referenced weight can be determined, for example, based on a time or interval during which the content element was displayed to/viewable by user 130 via display device 104 of device 102A.

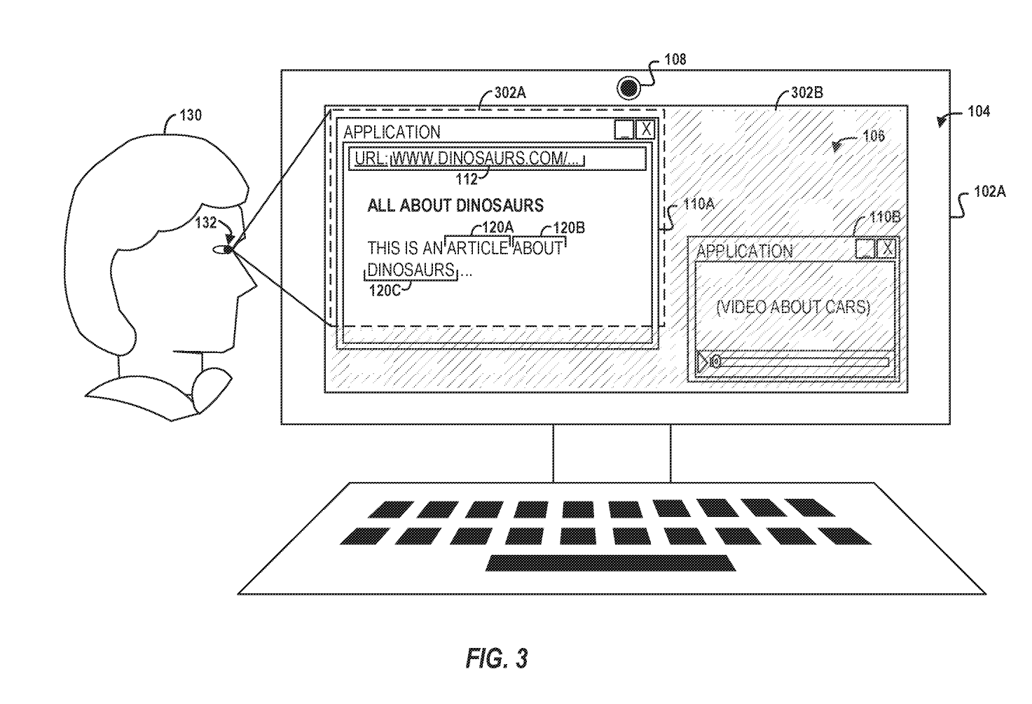

Moreover, in certain implementations content processing engine 202 can further incorporate or otherwise leverage various eye-tracking techniques. For example, FIG. 3 depicts an example scenario in which content processing engine 202 utilizes inputs (which originate from tracking component(s) 108 and indicate/reflect the direction in which eyes 132 of user 130 are directed, the consistency/steadiness of the gaze of the user 130, etc.) to compute/determine a region of the user interface (here, region 3024 as shown in FIG. 3) at which the user is looking. Upon determining, for example, that the eyes of the user were directed towards a particular region of the user interface (e.g., region 3024 as shown in FIG. 3), a weight 230 can be associated with those content element(s) determined to be present within the region. For example, the referenced weight can reflect that the associated content element was viewed by the user 130 for a significant period of time. The weight can be associated with those content element(s) determined to be present within the region (e.g., content elements 120A, 120B, and 120C which are present within region 302A, as shown in FIG. 3).

Content processing engine 202 can also configure/enable device 102A to identify, determine, and/or otherwise obtain various additional information. For example, content location(s) 240 and/or the application(s) 250 within which such content element(s) are presented can be identified/determined. Such content location(s) can be, for example, a URL, file location, etc. of the content element(s) depicted within user interface 106. The referenced application(s) can be, for example, a web browser, media player, etc. within which such content element(s) are presented. In certain implementations, such content location(s) and/or applications) can be identified using OCR and/or object recognition techniques, while in other implementations such information can be obtained based on metadata and/or other system information of device 102A (which can reflect the applications that are executing at the device 102A, the local/remote content/files which such applications are accessing/requesting, etc.).

As shown in FIG. 2, device 102A can also include data store 214. Data store 214 can be, for example, a database or repository that stores various information, including but not limited to image(s), content elements, timestamps, weights, content locations, and applications. In certain implementations data store 214 can be stored in memory of device 102A (such as memory 730 as depicted in FIG. 7 and described in greater detail below).

Content processing engine 202 can also configure/enable device 102A to generate content index 208. Content index 208 can be an index that contains/reflects the various content element(s) identified/extracted from the captured image(s), as described herein. As described in detail herein, upon receiving a search query, search engine 204 can utilize content index 208 to identify content element(s) that correspond to the search query. Image(s) that correspond to such identified content elements can then be retrieved and presented to the user, such as in a manner described herein. In doing so, the described technologies enable the storage of visual content (and related information) that has been viewed by/displayed to a user, as well as the indexing of such content in a manner that enables subsequent retrieval (e.g., in response to a search query).

Device 102A can also include security engine 206 which can configure/enable the device to ensure the security of image(s) 200 (and/or any other related information described herein). For example, it can be appreciated that certain content presented to user 130 via device 102A can be sensitive, confidential, private, etc. Accordingly, security engine 206 can, for example, operate in conjunction with content processing engine 202. In doing so, when sensitive, confidential, etc., content is identified (e.g., upon detecting personal financial information, personal medical information, etc.), security engine can ensure that image(s) (of the user interface that contain such content) will not be stored in data store 214, and/or will be stored in a manner that redacts such sensitive, personal, etc., content. Moreover, in certain implementations security engine 206 can enable user 130 to ‘opt-in,’ ‘opt-out,’ and/or otherwise configure various security parameters, settings, etc., with respect to the operation of the described technologies. For example, the user can be able to configure what types of content should or should not be stored (e.g., only store content that is publicly available such as websites, don't store content containing identifying information such as name, address etc.). Additionally, in certain implementations security engine 206 can utilize various types of data encryption, identity verification, and/or related technologies to ensure that the content cannot be accessed/retrieved by unauthorized parties. In doing so, security engine 206 can ensure that the described technologies enable the described benefits and technical improvements to be realized while maintaining the security and privacy of the user's data.

At this juncture it should be noted that while many of the examples described herein are illustrated with respect to a single device (e.g., 102A), this is simply for the sake of clarity and brevity. However, it should be understood that the described technologies can also be implemented (in any number of configurations) across multiple devices. For example, as shown in FIG. 2, device 102A can connect to and/or otherwise communicate with account repository 260 and/or various devices 102B, 102C via network 212. Network 212 can include one or more networks such as the Internet, a wide area network (WAN), a local area network (LAN), a virtual private network (VPN), an intranet, and the like. Account repository 260 can be, for example, a server, database, computing device, storage service, etc., that can store content (e.g., image(s) 200, content elements 210A, 210B, content index 208, etc., as shown in FIG. 2) within/with respect to an account associated with user 130. In doing so, in a scenario in which user 130 is subsequently utilizing another device (e.g., device 102B, which can be another computer, smartphone, etc.) the user can retrieve (e.g., upon providing the appropriate account credentials) or otherwise leverage such content stored in account repository 260 (despite the user having originally viewed the content via device 102A). As noted above, even in such a scenario, security engine 206 is operative to configure or otherwise enable the various device(s) and/or account repository 260 to operate in a manner that ensures that the privacy and security of the referenced content is maintained at all times.

Further aspects and features of device 102A are described in more detail in conjunction with FIGS. 2-7, below.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

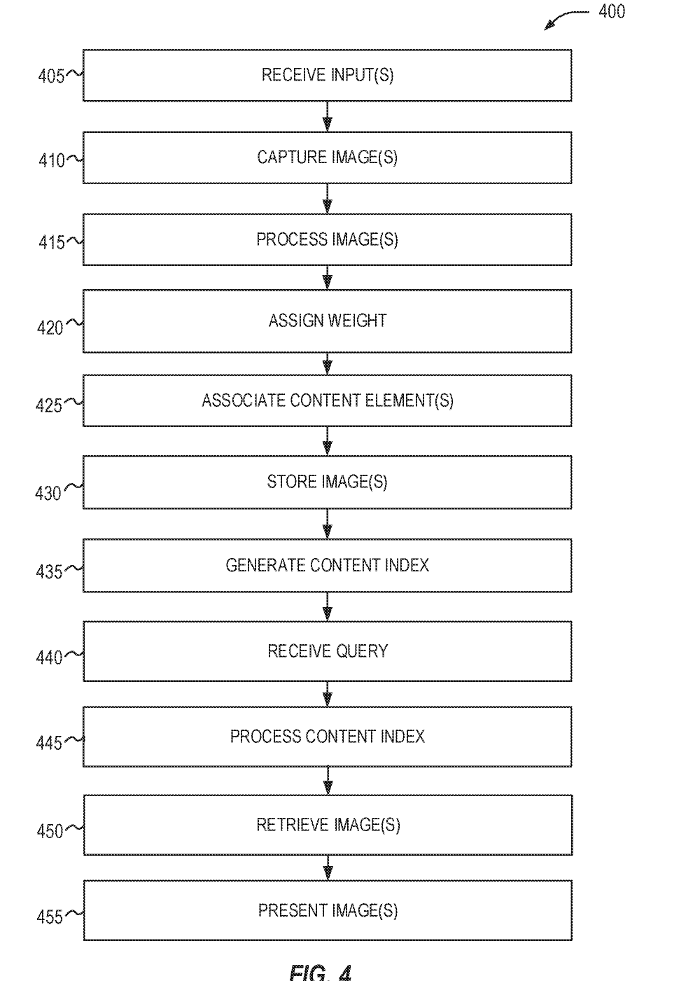

FIG. 4 is a flow chart illustrating a method 400, according to an example embodiment, for the index, search, and retrieval of user-interface content. The method is performed by processing logic that can comprise hardware (circuitry, dedicated logic, etc.), software (such as is run on a computing device such as those described herein), or a combination of both. In one implementation, the method 400 is performed by one or more elements depicted and/or described in relation to FIG. 1 and/or FIG. 2 (including but not limited to device 102A). In some other implementations, the one or more blocks of FIG. 4 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should he appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 405, one or more inputs can be received. In certain implementations, such inputs can be received from one or more tracking components 108, such as a sensor, camera, etc. Such input(s) can, for example, indicate or otherwise reflect that the eye(s) 132 of a user 130 are directed to a particular area, region, segment, etc., of a user interface 106. For example, FIG. 3 depicts an example scenario in which tracking component(s) 108 of device 102A identify and/or otherwise detect or determine (e.g., using various eye-tracking techniques) the position and/or direction of the eye(s) 132 of user 130. The position/direction of the eyes 132 of the user 130 can then be compared and/or correlated with the user interface 106 being presented on the display device 104 of device 102A. In doing so, region 302A of the user interface 106 with respect to which the eyes 132 of the user 130 are directed can be determined (as well as other region(s) 302B of the user interface with respect to which the eyes 132 of the user 130 are not directed—depicted with shading in FIG. 3). In certain implementations, various aspects of operation 405 can he performed by device 102A and/or content processing engine 202. In other implementations such aspects can be performed by one or more other elements/components, such as those described herein.

At operation 410, one or more images 200 can be captured. In certain implementations, the referenced images can be still image(s) (e.g., in .jpg, .bmp, .png, etc. digital formats) and/or video(s) (e.g., in .avi, .mpeg, etc. digital formats). Additionally, in certain implementations such image(s) can he compressed using one or more codec(s) (e.g., H.264) and/or can be captured/stored by various components of device 102A such as processors 710 (e.g., a GPU utilizing hardware compression, as described in detail below with respect to FIG. 7). Such image(s) can depict and/or otherwise reflect the visual presentation of user interface 106 as presented to user 130 via display device 104 of device 102A. In certain implementation(s), such image(s) 200 can be captured in response to a change in the framebuffer of device 102A (which can he stored in memory 732, as described with respect to FIG. 7 and which can contain the respective pixels and/or related display information for presentation on display device 104). In certain implementations, various aspects of operation 410 can be performed by device 102A and/or content processing engine 202, while in other implementations such aspects can he performed by one or more other elements/components, such as those described herein.

In certain implementations, the captured images 200 can reflect the entire user interface 106 as presented to the user 130 (e.g., as depicted in FIG. 1). However, in other implementations, the region(s) of the user interface 106 with respect to which the eyes 132 of the user 130 can be determined to be directed towards (e.g., region 302A of user interface 106 as depicted in FIG. 3) can be captured as images 200. In such a scenario, the remaining region(s) (with respect to which the eyes 132 of the user 130 are not determined to be directed towards—e.g., region 302B as depicted in FIG. 3) are not captured/reflected within the image(s) 200. By utilizing the determined direction of the eves of the user to dictate which region(s) of the user interface 106 are to be captured, the efficiency and performance of the described technologies can be improved. For example, fewer computing and/or storage resources may be needed to capture only a portion of the user interface 106 (as opposed to capturing all of it). Additionally, by capturing those region(s) of the user interface 106 with respect to which the eves of the user are determined to be directed, when such image(s) 200 are subsequently retrieved (e.g., in response to a search query, as described herein), those region(s) with respect to which the eyes of the user are determined to be directed (and are thus more likely to be relevant to the user) can be retrieved (while the remaining region(s)—which the eyes of the user were not directed towards and are thus less likely to be relevant to the user—will not be retrieved).

At operation 415, one or more images (such as the image(s) captured at operation 410) can be processed. In doing so, one or more content elements, such as content element(s) depicted or otherwise reflected within the one or more images (such as the image(s) captured at operation 410) can be identified. For example, the captured image(s) (which, as noted herein can be still images, video, and/or any other such visual media format) can be processed, analyzed, etc. using various optical character recognition (OCR) techniques. In doing so, various alphanumeric characters, strings, words, text, etc., that are depicted and/or otherwise reflected within the captured image(s) can be identified. For example, an image 200 captured of user interface 106 as shown in FIG. 1 can be processed to identify various content elements such as ‘article’ (120A), ‘about’ (120B), and ‘dinosaurs’ (120C). In certain implementations, various aspects of operation 415 can be performed by device 102A and/or content processing engine 202. In other implementations such aspects can be performed by one or more other elements/components, such as those described herein.

Additionally, in certain implementations the referenced image(s) (e.g., those captured at operation 410) can be processed to identify content element(s) depicted within a particular region of a user interface. For example, as shown in FIG. 3, the region(s) of the user interface 106 with respect to which the eyes 132 of the user 130 can be determined to be directed towards (e.g., region 302A of user interface 106 as depicted in FIG. 3) can be processed to identify content element(s) depicted within such region(s). In contrast, the remaining region(s) with respect to which the eves 132. of the user 130 are not determined to be directed towards (e.g., region 302B as depicted in FIG. 3) may not necessarily be processed to identify content element(s). Alternatively, such remaining region(s) can be processed in a manner that is relatively less resource-intensive.

Moreover, in certain implementations the one or more images (e.g., those captured at operation 410) can he processed with respect/in relation to various inputs received from the tracking component(s) 108 (camera, sensor, etc.). For example, a chronological interval (e.g., one minutes, three minutes, etc.) during which the eye(s) 132 of the user 130 are directed towards certain content element(s) 120 can be determined. By way of illustration, as shown in FIG. 3, it can be determined that the eye(s) 132 of the user 130 are directed towards certain content element 120C (‘dinosaurs’) for two minutes.

At operation 420, a weight 230 can be assigned, e.g., to one or more content element(s) (such as those identified at operation 415). In certain implementations, such a weight can be computed and/or assigned to the referenced content element(s) based on the chronological interval that the eye(s) 132 of the user 130 were directed towards the content element(s). For example, FIG. 3, can reflect a scenario in which it is determined that the eye(s) 132 of the user 130 were directed towards content element 120C (‘dinosaurs’) for two minutes and towards content element 120A (‘article’) for 10 seconds. In such a scenario, the weight assigned to content element 120C can reflect that the eye(s) of the user were directed to such content element for a relatively longer period of time (reflecting that such content element can have additional significance to the user). Additionally, the weight assigned to content element 120A can reflect that the eye(s) of the user were directed to such content element for a relatively shorter period of time (reflecting that such content element can have less significance to the user). In certain implementations, various aspects of operation 420 can be performed by device 102A and/or content processing engine 202, while in other implementations such aspects can be performed by one or more other elements/components, such as those described herein.

In certain implementations, the referenced weight 230 (and/or a component thereof) can also reflect an amount of time that has transpired since the user viewed and/or was presented with a particular content element (as determined, for example, based on timestamp 220). For example, a content element that was viewed by/presented to the user 130 more recently can be assigned a higher weight (being that the user can be more likely to wish to retrieve such content). By way of further example, a content element viewed by/presented to the user 130 less recently can be assigned a lower weight (being that the user may be less likely to wish to retrieve such content).

At operation 425, one or more content element(s) (such as those identified at operation 415) can be associated with one or more image(s) (such as those captured at operation 410). For example, as shown in FIG. 3, various content elements 120A (‘article’), 120B (‘about’) and/or 1200 (‘dinosaurs’) can be associated with an image 200 of the user interface 106 (which, as noted above, can be an image of region 302A of the user interface). Additionally, in certain implementations a content location 112 of the content element(s) can be associated with the referenced image(s) 200. Such a content location can be, for example, a file path or network address where the content element(s) are stored or located (e.g., the URL ‘www.dinosaurs.com,’ as shown in FIG. 3). Additionally, the application within which the referenced content element(s) are presented (e.g., application 110A as shown in FIG. 3, which can be a web browser) can also be associated with the captured image(s) 200. In certain implementations, various aspects of operation 425 can be performed by device 102A and/or content processing engine 202. In other implementations such aspects can be performed by one or more other elements/components, such as those described herein.

At operation 430, the image(s) (e.g., those captured at operation 410) as associated (e.g., at operation 425) with the content element(s) (e.g., those identified at operation 415) can be stored. In certain implementations, such images (as associated with the referenced content element(s)) can be stored in relation to a user (e.g., the user 130 with respect to which user interface 106 was presented by device 102A). For example, FIG. 2 depicts image(s) 200 associated with various content elements (e.g., content element 210A and content element 210B) (which are further associated with additional items such as timestamp 220, weight 230, content location 240, and/or application 250). Such image(s) 200, content elements 210, etc., can be stored in data store 214.

It should be understood that data store 214 can be a database, repository, etc., that is associated with, assigned to, etc., user 130 (e.g., a user account assigned to such user). Accordingly, the image(s), content element(s), and related items stored in data store 214 are those which user 130 has viewed and/or been presented with by device 102A). Additionally, in a scenario in which such image(s), content elements(s), etc., are also stored/maintained at a central/remote storage device (e.g., in the case of a ‘cloud’ implementation that enables the user 130 to access/retrieve such image(s), etc., via multiple devices), such image(s), content element(s), etc., can be stored within a secure account that is associated with (and may only be accessible to) the user 130. In certain implementations, various aspects of operation 430 can be performed by device 102A and/or content processing engine 202, while in other implementations such aspects can be performed by one or more other elements/components, such as those described herein.

At operation 435, a content index 208 can be generated. In certain implementations, such a content index can be generated based on various content element(s) (e.g., those identified at operation 415). Additionally, in certain implementations index 208 can also include and/or incorporate various additional item(s) that are identified, determined, computed, etc., with respect to the various image(s), content element(s), etc. For example, content index 208 can also include respective weight(s) 230 (such as those computed and/or assigned at operation 420). In certain implementations, various aspects of operation 435 can be performed by device 102A and/or search engine 204, while in other implementations such aspects can be performed by one or more other elements/components, such as those described herein.

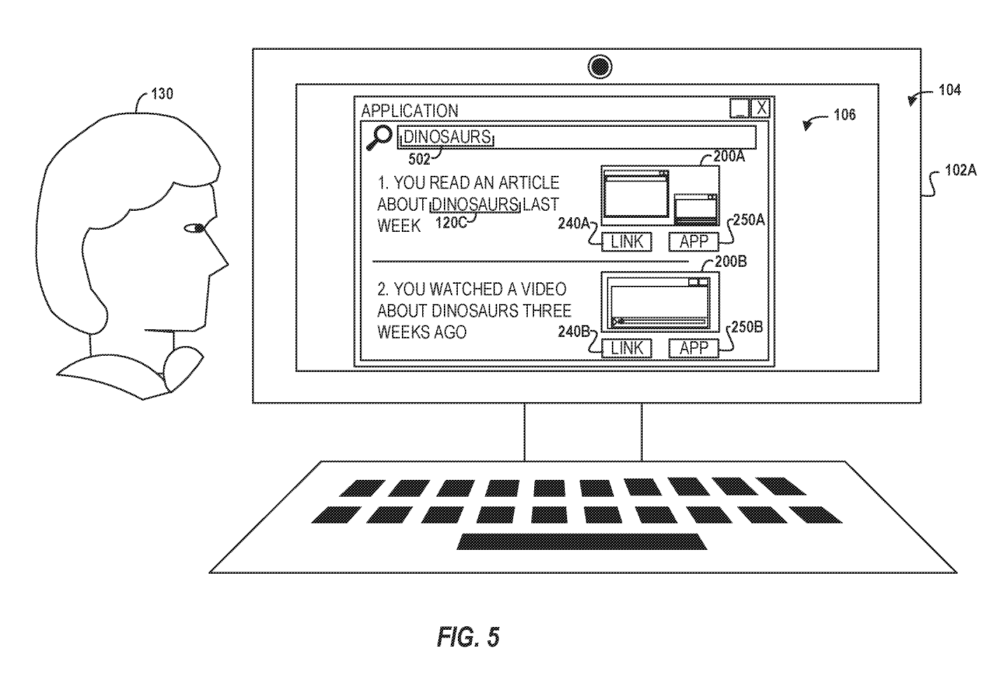

At operation 440, a search query can be received, such as from a user (e.g., the user with respect to which image(s) 200 were captured at operation 410). For example, FIG. 5 depicts an example scenario in which user 130 inputs (e.g., via one or more input devices such as a keyboard, touchscreen, voice command, etc.) a search query 502 (here, ‘dinosaurs’) into a search application. In certain implementations, various aspects of operation 440 can be performed by device 102A and/or search engine 204. In other implementations such aspects can be performed by one or more other elements/components, such as those described herein.

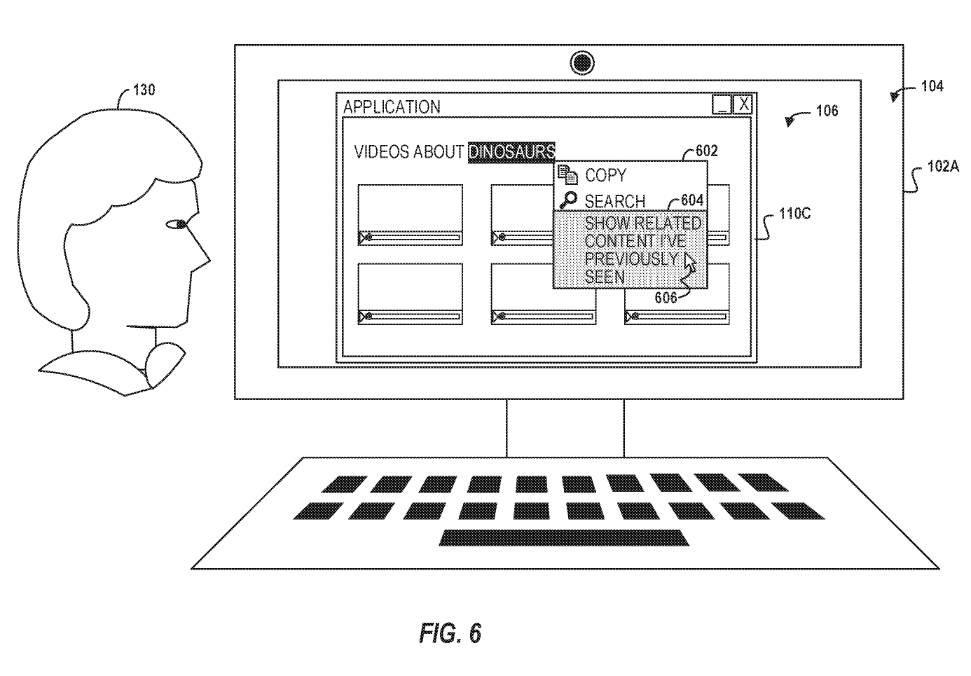

Moreover, in certain implementations, such a search query can be generated in various ways (e.g., in lieu of inputting the search query directly, as shown in FIG. 5). For example, such a search query can be generated based on/in response to a selection by the user 130 of various region(s) of the user interface 106 as depicted to the user 130 via device 102A. By way of illustration, FIG. 6 depicts an example scenario in which user interface 106 presents application 110C (showing ‘videos about dinosaurs’) to user 130. As shown in FIG. 6, upon selecting (e.g., via touch screen interaction, mouse click, e.g., a ‘right click’ operation, etc.) the word ‘dinosaurs’ as depicted within application 1100, a menu such as context menu 602 can be presented to the user 130. Such a menu 602 can include an option 604 (‘Show Related Content I've Previously Seen’) that corresponds to the retrieval of content associated with the selected item/element (here, ‘dinosaurs’) that the user 130 has previously viewed or otherwise been presented with. Upon selecting such an option 604 (e.g., by hovering pointer 606 over the region associated with option 604 and clicking or otherwise selecting such an option), a search query (here, corresponding to ‘dinosaurs’) can be generated.

At operation 445, the content index 208 (e.g., the content index generated at operation 435) can be processed. In doing so, various content element(s) that correspond to the search query can be identified. For example, upon receiving a search query for ‘dinosaurs,’ content index 208 can be search for instances of such a term (and/or related term(s)) present within the index. In certain implementations, various aspects of operation 445 can be performed by device 102A and/or search engine 204. In other implementations such aspects can be performed by one or more other elements/components, such as those described herein.

At operation 450, one or more image(s) (e.g., those captured at operation 410) that are associated (e.g., at operation 425) with content element(s) (e.g., those identified at operation 415) that correspond to the search query (e.g., the query received at operation 440) can be retrieved. For example, upon receiving a search query for ‘dinosaurs’ (such as in a manner depicted in FIG. 5 and/or FIG. 6), content index 208 can be searched to identify content elements (e.g., 210A, 210B, etc., as shown in FIG. 2) that correspond and/or relate to the search query. Upon identifying such content element(s) within the search index, the image(s) 200 (from which such content element(s) were originally identified/extracted) can be retrieved (e.g., from data store 214, as shown in FIG. 2). In certain implementations, various aspects of operation 450 can be performed by device 102A and/or search engine 204. In other implementations such aspects can be performed by one or more other elements/components, such as those described herein.

At operation 455, one or more image(s) (such as those retrieved at operation 450) can be presented to the user 130. In certain implementations, such retrieved image(s) can be presented to the user via display device (e.g., display device 104 of device 102A). By way of illustration, FIG. 5 depicts an example scenario in which image(s) 200A and image(s) 200B are presented to user 130 in response to a search query 502. Such image(s) 200A and/or 200B can be still image(s), video clips, etc. of the user interface 106 of device 102A as captured while user 103 was viewing and/or otherwise presented with content (e.g., an application, etc.) that included the content element (here ‘dinosaurs’) that corresponds/relates to the search query 502. In doing so, user 130 can retrieve and review content that he/she has viewed in the past, even in scenarios in which such content may not have otherwise been stored/indexed with respect to the user. In certain implementations, various aspects of operation 455 can be performed by device 102A and/or search engine 204. In other implementations such aspects can be performed by one or more other elements/components, such as those described herein.

Moreover, as shown in FIG. 5, in certain implementations various additional information can be presented to the user 130 in conjunction with the retrieved image(s) 200. For example, a retrieved image can be presented together with various selectable controls (e.g., buttons, links, etc.). When selected, such controls can enable the user to access the content location that corresponds to the content element (that was the subject of the search) and/or the application within which such content element was viewed/presented.

By way of illustration, FIG. 5 depicts image(s) 200A which can be a video or image(s) of the user interface 106 while content element 120C (here, ‘dinosaurs’) was presented to the user on the device 102A. As shown in FIG. 5, image(s) 200A can be presented in conjunction with various selectable controls. For example, one such control can correspond to a content location 240A (‘Link’) (e.g., the URL of the website within which the content element was identified. Another such control can correspond to an application 250A (‘App’) (e.g., a control to launch the application here a web browser within which the content element was previously viewed). As further depicted in FIG. 5, image(s) 200B (e.g., a video or image(s) of another instance in which user interface 106 presented content element 120C—i.e., ‘dinosaurs’—to the user, e.g., within a video/media player) can also be presented. Such image(s) 200B can also be presented together with controls corresponding to content location 240B (which can be a location of the video/media file being played within the depicted media player within which the content element was identified) and application 250B (e.g., a control to launch the media player application within which the content element was previously viewed).

As also shown in FIG. 5, the various retrieved image(s) 200 can be presented in conjunction with the content element(s) that correspond to the search query (e.g., as received at operation 440) with respect to which such image(s) were retrieved. For example, the content element 120C (‘dinosaurs’) can be presented together with the retrieved image(s) (e.g., 200A), with additional content that provides additional context with respect to when the content element was previously viewed (e.g., ‘You read an article about dinosaurs last week,’ as shown). Presenting the image(s) 200 and content element(s) in such a manner can further enable the user 130 to easily identify the content that he/she is seeking.

It should also be noted that, as depicted in FIG. 5, the manner in which the various retrieved image(s) 200A, 200B are presented/prioritized (e.g., in response to the search query) can be dictated based on the respective weight(s) associated with each respective content element (e.g., as described above). For example, image(s) that were captured more recently (e.g., ‘last week,’ as shown in FIG. 5) can be assigned a higher weight than image(s) captured less recently (e.g., ‘three weeks ago’). Additionally, in certain implementations the referenced weights can also be dictated based on various inputs originating from tracking component(s) 108. For example, content that the user is determined to have looked at, read, etc. for a longer period of time can be assigned a higher weight than content that the user looked at, etc., for a relatively shorter period of time. In doing so, the retrieval of content that is more likely to be of interest to the user can be prioritized.

As noted above, while many of the examples provided herein are illustrated with respect to a single device (e.g., device 102A), the described technologies can also be implemented across multiple devices. For example, as described in detail herein with respect to FIG. 2, a user can initially utilize device 102A and corresponding image(s), content, etc. can be captured and stored in account repository 260. Subsequently, the user can utilize device 1023 to retrieve or otherwise leverage the image(s), content, etc. stored in account repository 260 (despite having originally viewed such content via device 102A). In doing so, the described technologies can enable a user to utilize one device to retrieve images, content, etc. that the user originally viewed via other device(s). Such functionality can be advantageous in scenarios in which users frequently utilize multiple devices and may wish to retrieve images, content, etc., previously viewed on one device while utilizing another device. Additionally, as noted above, in certain implementations security engine 206 can verify the identity of the user (e.g., via receipt of the correct account credentials) prior to allowing device 102B to access account repository 260 (and/or a particular account within the repository).

It should also be noted that while the technologies described herein are illustrated primarily with respect to the index, search, and retrieval of user interface content, the described technologies can also be implemented in any number of additional or alternative settings or contexts and towards any number of additional objectives. It should be understood that farther technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules, A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-6 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 7 is a block diagram illustrating components of a machine 700, according to some example implementations, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein can be executed. The instructions 716 transform the general, non-programmed machine into a particular machine programmed to carry out the described and illustrated functions in the manner described. In alternative implementations, the machine 700 operates as a standalone device or can be coupled (e.g., networked) to other machines. In a networked deployment, the machine 700 can operate in the capacity of a server machine or a client machine in a server-client network environment, or as a peer machine in a peer-to-peer (or distributed) network environment. The machine 700 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 can include processors 710, memory/storage 730, and I/O components 750, which can be configured to communicate with each other such as via a bus 702. In an example implementation, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 712 and a processor 714 that can execute the instructions 716. The term “processor” is intended to include multi-core processors that can comprise two or more independent processors (sometimes referred to as “cores”) that can execute instructions contemporaneously. Although FIG. 7 shows multiple processors 710, the machine 700 can include a single processor with a single core, a single processor with multiple cores (e.g., a multi-core processor), multiple processors with a single core, multiple processors with multiples cores, or any combination thereof.

The memory/storage 730 can include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 can also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions (e.g., instructions 716) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 can include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 can include many other components that are not shown in FIG. 7. The I/O components 750 are grouped according to functionality merely for simplifying the following discussion and the grouping is in no way limiting. In various example implementations, the I/O components 750 can include output components 752 and input components 754. The output components 752 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 750 can include biometric components 756, motion components 758, environmental components 760, or position components 762, among a wide array of other components. For example, the biometric components 756 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 can include acceleration sensor components (e.g., accelerometer), gravitation sensor components, rotation sensor components (e.g., gyroscope), and so forth. The environmental components 760 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 762 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 750 can include communication components 764 operable to couple the machine 700 to a network 780 or devices 770 via a coupling 782 and a coupling 772, respectively. For example, the communication components 764 can include a network interface component or other suitable device to interface with the network 780. In further examples, the communication components 764 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 can be another machine or any of a wide variety of peripheral devices (e.g., a peripheral device coupled via a USB).

Moreover, the communication components 764 can detect identifiers or include components operable to detect identifiers. For example, the communication components 764 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 764, such as location via Internet Protocol (IP) geolocation, location via Wi-Fi® signal triangulation, location via detecting an NFC beacon signal that can indicate a particular location, and so forth.

In various example implementations, one or more portions of the network 780 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 can include a wireless or cellular network and the coupling 782 can be a Code Division Multiple Access (CDMA) connection, a Global System for Mobile communications (GSM) connection, or another type of cellular or wireless coupling. In this example, the coupling 782 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 can be transmitted or received over the network 780 using a transmission medium via a network interface device (e.g., a network interface component included in the communication components 764) and utilizing any one of a number of well-known transfer protocols (e.g., HTTP). Similarly, the instructions 716 can be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter may be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
capturing an image of a user interface as presented to a user via a display device;
processing the image to identify a content element depicted within the image;
associating the content element with the image; and
storing, in relation to the user, the image as associated with the content element.

2. The system of claim 1, wherein the memory further stores instructions for causing the system to perform operations comprising receiving an inputs from a tracking component, the input indicating that one or more eyes of the user are directed to a first region of the user interface.

3. The system of claim 2, wherein capturing the image comprises capturing an image of the first region of the user interface.

4. The system of claim 2, wherein processing the image comprises processing the image to identify a content element depicted within the first region of the user interface.

5. The system of claim 2, wherein processing the image comprises processing the image with respect to the input received from the tracking component to determine a chronological interval during which the one or more eyes of the user are directed to the content element.

6. The system of claim 5, wherein the memory further stores instructions for causing the system to perform operations comprising assigning a weight to the content element based on the chronological interval.

7. The system of claim 1, wherein processing the image comprises processing the image using optical character recognition (OCR) to identify one or more alphanumeric characters depicted within the o image.

8. The system of claim 1, wherein associating the content element comprises associating a content location of the content element with the image.

9. The system of claim 1, wherein associating the content element comprises associating, with the image, an application within which the content element is presented.

10. The system of claim 1, wherein the memory further stores instructions for causing the system to perform operations comprising generating a content index based on the content element.

11. The system of claim 10, wherein the memory further stores instructions for causing the system to perform operations comprising:
receiving a search query from the user;
processing the content index to identify one or more content elements that correspond to the search query;
retrieving at least one image that is associated with at least one of the one or more content elements that correspond to the search query; and
presenting the at least one image to the user via the display device.

12. The system of claim 11, wherein receiving a search query comprises generating a search query based on a selection of a region of the user interface.

13. The system of claim 11, wherein presenting the at least one image comprises presenting the at least one image in conjunction with the one or more content elements that correspond to the search query.

14. A method comprising:
receiving an input from a tracking component, the input indicating that one or more eyes of a user are directed to a first region of a user interface presented to the user via a display device;
capturing an image of the first region of the user interface;
processing the image to identify a content element depicted within the first region of the user interface;
associating the content element with the image; and
storing, in relation to the user, the image as associated with the content element.

15. The method of claim 14, wherein processing the image comprises processing the image with respect to the input received from the tracking component to determine a chronological interval during which the one or more eyes of the user are directed to the content element.

16. The method of claim 15, further comprising assigning a weight to the content element based on the chronological interval.

17. The method of claim 14, further comprising venerating a content index based on the content element.

18. The method of claim 17, further comprising:
receiving a search query from the user;
processing the content index to identify one or more content elements that correspond to the search query;
retrieving at least one image that is associated with at least one of the one or more content elements that correspond to the search query; and
presenting the at least one image to the user via the display device.

19. A non-transitory computer readable medium having instructions stored thereon that, when executed by a processing device, cause the processing device to perform operations comprising:
receiving an input from a tracking component, the input indicating that one or more eyes of a user are directed to a first region of a user interface presented to a user via a display device;
capturing an image of the first region of the user interface;
processing the image to identify a content element depicted within the first region of the user interface;
associating the content element with the image;
storing, in relation to the user, the image as associated with the content element;
generating a content index based on the content element; and
in response to receipt of a search query,
identifying one or more content elements that correspond to the search query, and
presenting at least one image that is associated with at least one the one or more content elements that correspond to the search query.

20. The computer-readable medium of claim 19, wherein the search query comprises a search query generated based on a selection of one or more regions of the user interface.
